(19) United States
(12) Patent Application Publication
(10) Pub. No.: US 2012/0296751 A1
(43) Pub. Date: Nov. 22, 2012

(54) POINT OF SALE DEVICE FOR USE WITH A SHOPPING CART

(75) Inventor: David Napper, St. Catharines (CA)

(73) Assignee: EXPOSE RETAIL STRATEGIES, INCORPORATED, St. Catharines, ON (CA)

(21) Appl. No.: 13/574,654

(22) PCT Filed: Jan. 24, 2011
(86) PCT No.: PCT/CA2011/000079

§ 371 Date: Jul. 23, 2012

Related U.S. Application Data
(60) Provisional application No. 61/282,332, filed on Jan. 25, 2010.
(60) Provisional application No. 61/344,046, filed on May 13, 2010.

(51) Int. Cl. G06Q 20/20

(52) U.S. Cl. 705/23

(57) ABSTRACT

A point of sale device for use with a shopping cart, the shopping cart having a basket for holding products, the basket having a bottom, and an upstanding sidewall extending from said bottom and defining open top. The point of sale device has a product detector for monitoring and validating the products in the basket, a control unit communicating with the product detector, the control unit having a user interface with a display screen, and an information detector communicating with the control unit for detecting product information and sending the product information to the control unit. The control unit communicates with the store's accounting/inventory system and has a calculator which calculates the cost of the products in the basket of the shopping cart using the product information and displays at least the cost of the products on the display screen.

### FIELD OF THE INVENTION

The present invention relates to shopping carts, and in particular to a point of sale device for purchasing products in a shopping cart.

### BACKGROUND OF THE INVENTION

Many consumers use shopping carts when selecting items to purchase at stores such as grocery stores. Consumers may, for example, travel around the grocery store and periodically place items for purchase in a shopping cart.

To purchase the items the consumer then typically waits in line and processes their items through either an automated checkout or a clerk-operated checkout.

A consumer's free time is therefore being spent shopping and waiting in line to purchase selected items.

The present invention addresses at least one of the above problems.

### SUMMARY

A point of sale device for use with a shopping cart, the shopping cart having a basket for holding products, the basket having a bottom, and an upstanding sidewall extending from said bottom and defining open top. The point of sale device has a product detector for monitoring and validating the products in the basket, a control unit communicating with the product detector, the control unit having a user interface with a display screen, and an information detector communicating with the control unit for detecting product information and sending the product information to the control unit. The control unit communicates with the store's accounting/inventory system and has a calculator which calculates the cost of the products in the basket of the shopping cart using the product information and displays at least the cost of the products on the display screen.

The product detector may be a weight detection system being either a pad mounted on the bottom of the basket or by way of load cells either mounted inside the basket or having the basket mounted to them for weighing products in the basket.

The product detector may also include video analytic software utilizing algorithms to monitor the activity inside of the basket ensuring items are not put into the basket without having been scanned.

The information detector may be a bar code reader and the product information may be encoded on a bar code.

Alternatively, or as well as the information detector may be a radio-frequency identification (“RFID”) tag reader and the product information may be encoded on an RFID tag. Similarly, the product detector may be an RFID tag reader.

The information detector may also be a video analytic tool that reads a bar code via a video camera mounted inside the basket.

The open top of the shopping cart may have an edge extending thereabout and, the information detector may be attached to the edge for detecting the product information from products as the products pass past the information detector through the open top and into the interior of the shopping cart.

The control unit may attach to the shopping cart so that the user interface faces the user.

The calculation of the cost of the product may be performed in real-time in response to receiving product information.

The point of sale device may have a receipt dispenser communicating with the control device for dispensing receipts.

The control unit may also communicate via wifi to with a central kiosk or existing self serve checkout terminal where the receipt can be printed there.

The control unit may have a pay now button for initiating the payment process which ends with the receipt dispenser dispensing a receipt or emailing a receipt to the email address of the user.

The point of sale device may further have a card swipe communicating with the control unit for reading a payment card. The point of sale device may have a transmitter for sending payment card information to an issuing institution and a receiver for receiving confirmation of payment from the issuing institution.

The point of sale device may operate without a card swipe by sending a request via wifi to a server located in the store or via the internet to a site in order to execute the transaction, as the payment method details are stored on that server as part of the customers account.

At least one of the control unit and the card swipe may have a numerical keypad for receiving a pin number.

The user interface may be a touch screen interface.

The control unit may be powered by a lithium battery.

The point of sale device may have a scale for weighing selected of the items, the scale communicating with a bar code printer for printing a corresponding bar code.

A method of purchasing items, comprising the steps of: (i) providing a point of sale device mounted to a shopping cart as defined above; (ii) inserting at least one item with a bar code into the shopping cart so that the bar code reader reads the bar code; (iii) select “pay now” button; and (iv) swiping at least one of a credit card or a debit card.

### BRIEF DESCRIPTION OF THE DRAWINGS

In order that the subject matter may be readily understood, embodiments are illustrated by way of examples in the accompanying drawings, in which:

FIG. 1 is a perspective view of a shopping cart;

FIG. 2 is a top plan view of a control unit in isolation;

FIG. 3 is a top plan view of the shopping cart of FIG. 1;

FIG. 4 is a perspective view of a shopping cart docking system;

FIG. 5 is a perspective view of a shopping cart with a video camera;

FIG. 6 is a perspective view of a shopping cart of FIG. 5; and

FIG. 7 is a flow chart showing a method of purchasing items using the shopping cart and point of sale device;

FIGS. 8A through 8D are top plan views of an alternate embodiment of the control unit.

### DETAILED DESCRIPTION

Described is a shopping cart with a point of sale device. The point of sale device may comprise a product detector, a control unit and an information detector.

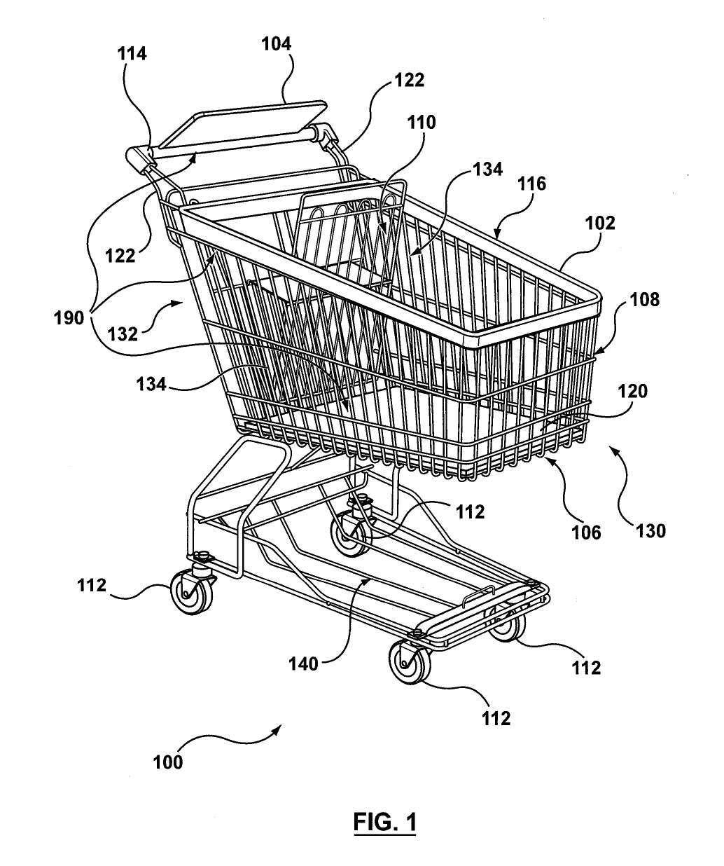

FIG. 1 shows an embodiment of the shopping cart 100 with a point of sale device 190. The product detector may be a weight detection pad 120, for example, and the information detector may be a bar code reader 102. The point of sale device 190 also has a control unit 104.

The shopping cart 100 has a basket 108 having a bottom 106 and upstanding sidewalls 107 extending about the bottom 106 and defining an interior 110 and an open top. The sidewalls 107 define edges 116 opposite the bottom 106 extending about the interior 110. The basket is for holding products in its interior. Products or items can include, for example, groceries from a grocery store. The shopping cart 100 has a front 130 and a rear 132.

The basket 108 is supported by a frame 140 which in turn is supported for rolling over an underlying surface by wheels 112 connected to the frame. There may be a second basket 134 that fits inside the basket 108.

Two handlebar supports 122 extend from a rear 132 of the basket adjacent the edge 116. A handle bar 114 for pushing the shopping cart 100 extends between, and is mounted to the handle bar supports 122.

In the embodiment shown in the figures, the handle bar 114 is a metal rod extending between the handle bar supports 122.

A control unit 104 is preferably removably attached to the handle bar 114. The attachment of the control unit 104 to the handlebar 114 may be by a clip or other similar fastener. The control unit 104 is shown as a substantially rectangular planar member that is angled upward to face a user or consumer (not shown).

The control unit 104 has a memory for storing information or data and a processor for executing instructions.

The control unit 104 may be connected to a wireless network, such as the Internet or a local area network, in order to receive and send messages or data.

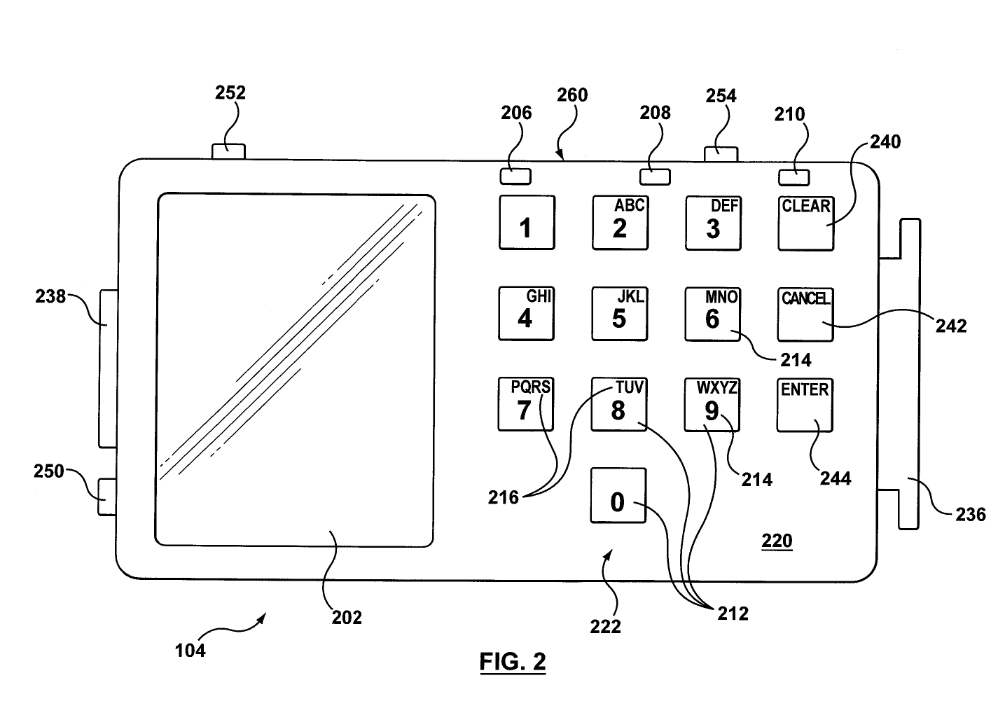

FIG. 2 shows the front surface 220 of a first embodiment of the control unit 104. The front surface 220 of the control unit 104 faces outward from the shopping cart 100 toward the user. A user interface 202, such as the screen illustrated, occupies part of the front surface 220. A numerical keypad 222 or PIN pad is located on the front surface 220 next to the user interface 202. The keypad 222 may, for example, be similar to a keypad 222 found on a telephone or a calculator. The buttons or keys 212 on the keypad 222 may include character keys 212 having numerals 214 and/or letters 216 and may include mathematical or logical operation keys such as +. −. /, * and =.

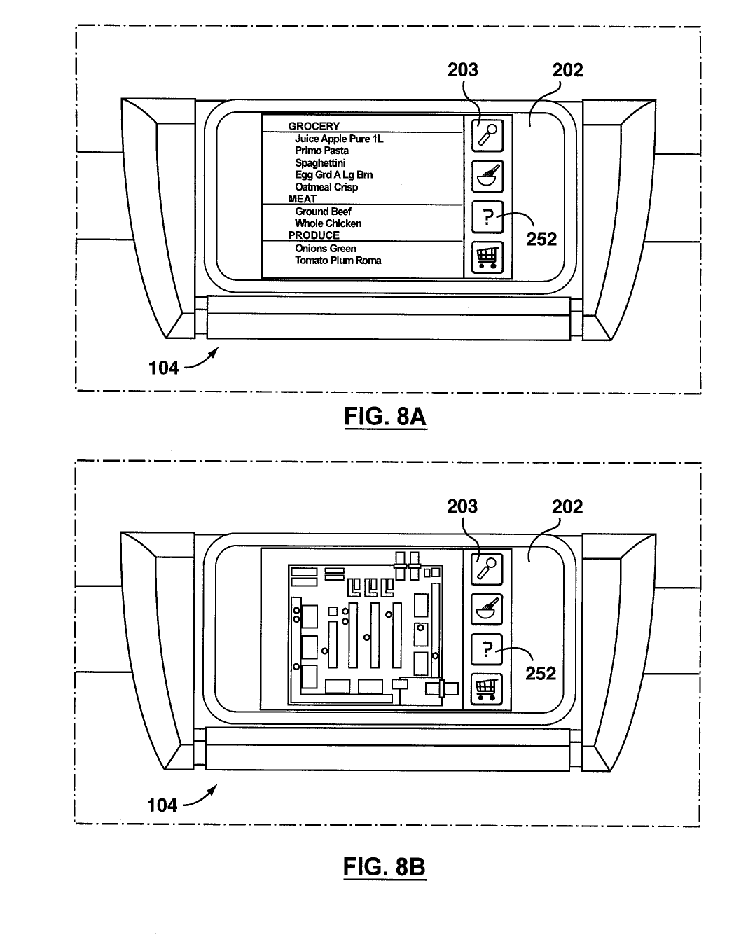

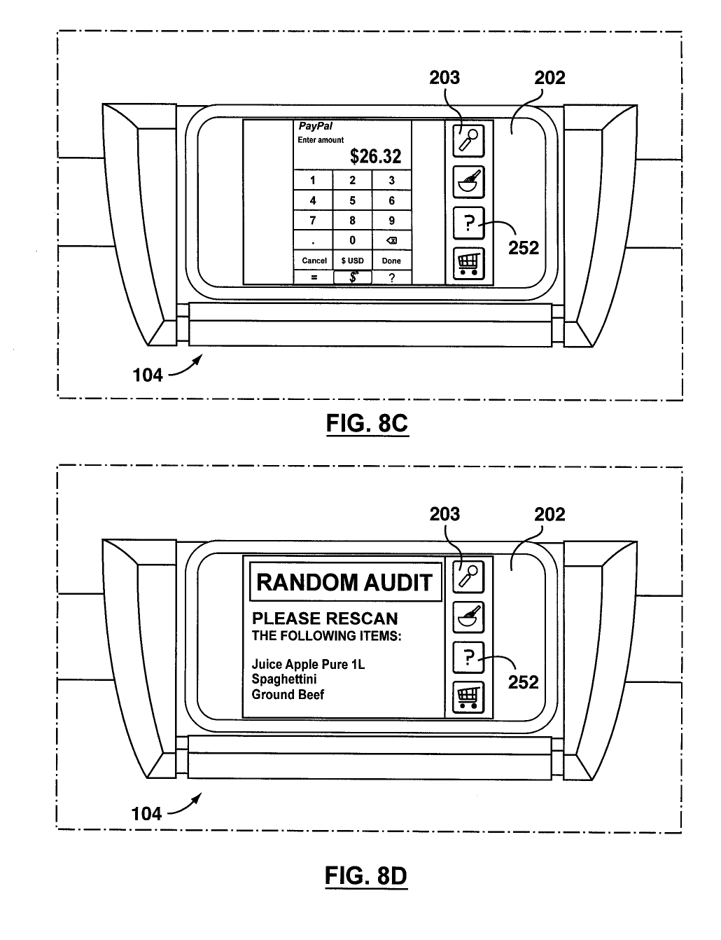

Alternatively, the user interface 202 may be a touch screen interface such as shown by reference 104 in FIGS. 8A through 8D.

The buttons 212 on the keypad 222 may be used to enter information into or manipulate information on the memory of the control unit 104 and/or to execute instructions on the processor of the control unit 104. Typically, when a button 212 is pressed a corresponding instruction is executed and/or a corresponding character appears on the user interface 202, similar to the operation of a calculator, as would be familiar to a skilled person. For example, if a user enters “2” the number “2” appears on the user interface. Then if a user enters “+”, followed by “3”, followed by “=” the memory would store the inputs, “2”, “+”, “3” and “=” and the processor would execute the mathematical instruction 2+3. The user interface 202 may then display the result of the operation, “5”. Other mathematical instructions and operations performed by such a keypad 222 are familiar to a person of skill in the relevant art.

A power button 250, a help button 252 and a “pay now” button 254 may each be located on the control unit 104. The power button 250 allows the control unit 104 to be turned on or off. For example, if the control unit 104 is off (i.e. not receiving any power form a power source such as a battery), and the power button 252 is pressed, the control unit 104 may be turned on so that the control 104 receives power from a power source such as a battery.

LED indicator lights 206, 208, 210 may be located on the front surface 220 of the control unit 104. In the embodiment shown in FIG. 2, there are three LED indicator lights 206, 208, 210. When the control unit 104 is “on” (i.e. the control unit 104 is receiving power) one of the LED indicator lights 206 may be illuminated to indicate to a consumer or attendant that the control unit 104 is indeed “on”.

A receipt dispenser 236 may also be attached to or integral with the control unit 104. Alternatively, the receipt dispenser 236 may be remotely located and may communicate with the control unit 104 over a network, such as the Internet or a local area network. For example, the receipt dispenser 236 may be located at or near the check-out counter of a grocery store. The receipt dispenser 236 may include a rotatable bar (not shown) for holding a roll of receipt paper. The receipt dispenser 236 may also include a mechanism for rotating the bar to advance the receipt paper. The receipt dispenser 236 also includes a printing mechanism for printing receipt information onto the receipt paper. Receipt dispensers 236 are known in the art and the details of implementation would be familiar to a person of skill in the art.

A tag remover 238 may also be attached to the control unit 104. The tag remover 238 comprises a clip for removing tags from products. For example, plastic security tags may be removed from a product using the tag remover 238. Alternatively, the tag remover 238 may be a separate component (i.e. not attached to the control unit 104. For example, the tag remover 238 may be attached to the shopping cart 100 or may be a separate handheld device.

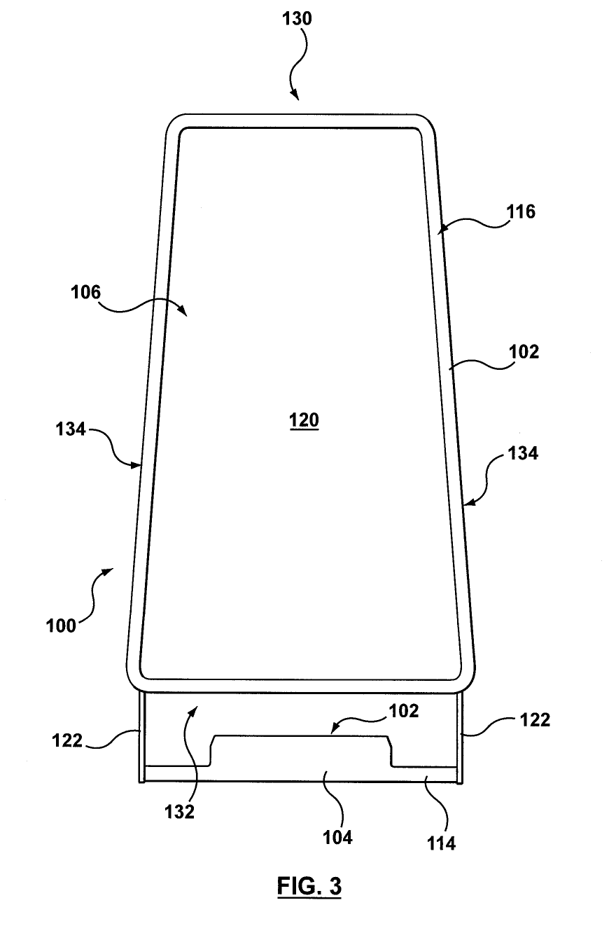

Referring to FIGS. 1 and 3, the bar code reader 102 may be attached along the top edges 116 of the basket 108 thereby surrounding the opening of the basket 108. Alternatively, the bar code reader 102 may only be attached on a portion of the top edge 116 of the basket 108. By way of further alternative, the bar code reader 102 may be separate from the shopping cart 100, for example the bar code reader 102 may be a handheld device.

The bar code reader 102 is an electronic device for reading bar codes. The bar code reader 102 may consist of a light source, a lens and a light sensor translating optical impulses into electrical ones. The bar code reader 102 may also have memory for storing data or information (such as bar code information) and a processor for executing instructions. The bar code reader 102 may also comprise a decoder circuitry for analyzing the bar code's image data, which may be read into the bar code reader by the sensor and stored in the bar code reader's 102 memory. A lithium battery (not shown) may provide power to the bar code reader 102.

The bar code reader 102 may be connected to a wireless network, such as the Internet or a local area network, in order to communicate with the control unit 104.

In an alternative embodiment an RFID tag reader (not shown) can be used in place of or in addition to the bar code reader 102. The RFID tag reader may read RFID tag information encoded on RFID tags located on products or items placed into the shopping cart 100 basket 108. The RFID tag reader is discussed in more detail below.

The product detector is for monitoring products in the basket of the shopping cart 100. This monitoring may, for example, comprise verifying the existence of products in the basket of the shopping cart 100. The product detector may, for example, be a weight detection pad 120 (as shown in FIGS. 1 and 3).

A weight detection pad 120 may be attached to or mounted on the bottom 106 of the interior 110 of the basket 108. Alternatively the weight detection pad 120 may simply rest on the bottom 106 of the interior 110 of the basket 108. In further alternative embodiments, the weight detection pad 120 is not located in the interior 101 of the basket 108. For example, weight detection means may be mounted between the basket 108 and the frame 140 to detect changes in weight of the basket with its contents.

The weight detection pad 120 has a sensor for counting the number of products in the interior 100 of the shopping cart 100. For example, the weight detection pad may sense a change in the weight or force being applied to it and, depending on whether the change is an increase or a decrease in weight, it will be able to determine whether products are removed or placed into the shopping cart 100.

Alternatively, the weight detection pad 120 may measure the weight of objects or products placed on its surface.

Therefore, if a product is placed through the top opening of the interior 102 of the basket 108 and passes the bar code reader 102, the bar code reader 102 reads the product information encoded on the bar code of the product (if the product has a bar code) and when the product lands and rests on the weight detection pad 120, the weight detection pad 120 will detect the weight of the product. The weight detection pad 120 may also have a memory for storing information or data (such as the weight of the products or objects resting on the weight detection pad 120) and a processor for executing instructions. The weight detection pad 120 may cover the entire bottom 106 of the basket 108. Alternatively, the weight detection pad 120 may cover only a portion of the bottom of the basket 108. A lithium battery (not shown) may provide power to the weight detection pad 120.

The weight detection pad 120 may be connected to a wireless network, such as the Internet or a local area network, in order to communicate with the control unit 104.

Alternatively, the product detector may be a weight detection device which is suspended inside the basket of the shopping cart 100. When products are collected by a consumer for purchasing, they are placed inside the weight detection device in the shopping cart's 100 basket. This weight detection device may otherwise operate similarly to the weight detection pad 120 described above.

Alternatively, the basket of the shopping cart 100 may be connected to the frame 140 of the shopping cart 100 via a weight detection device. Such a weight detection device will monitor and/or measure the weight changes of the basket of the shopping cart 100. This weight detection device otherwise operates similarly to the weight detection pad 120 described above.

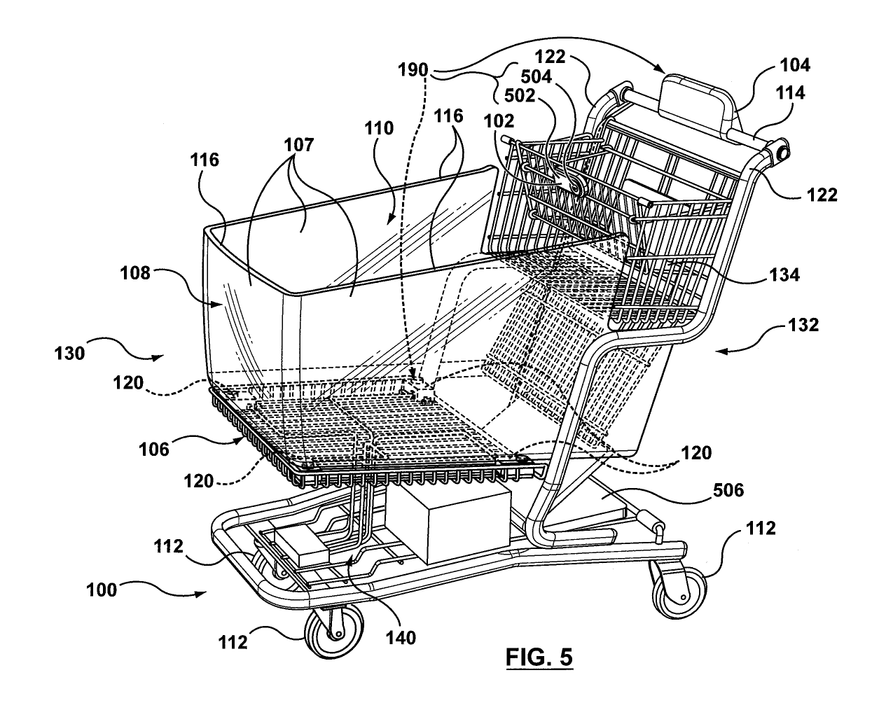

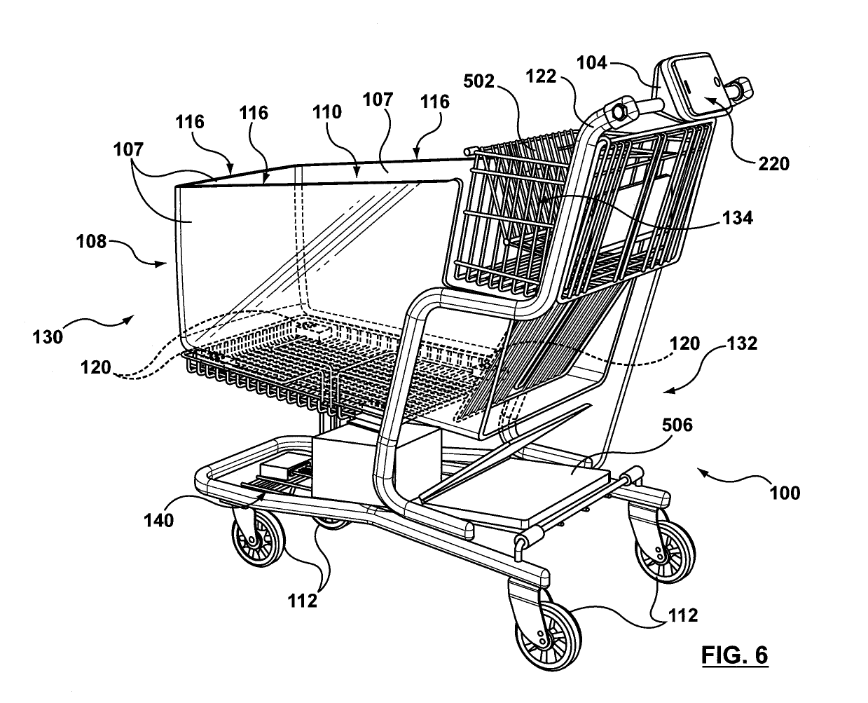

Referring to FIGS. 5 and 6, the weight detection device may comprise four load cells 120 that support the basket 108. The load cells 120 support the basket 108 on the frame 140 of the shopping cart 100. For example, each of the load cells 120 may be underneath a corner of the basket 108 and on top of a portion of the frame 140. Thus each time an item is placed in the interior 110 of the basket 108, the load cells 120 will measure the change in the load or weight on the basket 108 thereby measuring the weight of the item. The load cells may be placed inside of the basket as well having a plate mounted atop of them so that boxes or bags can be placed inside the basket the individual items can be verified by their weight.

The bar code scanner may, for example, be a separate hand held device that can be used in cooperation with the embodiment of the cart 100 shown in FIGS. 5 and 6.

The product detector may also or otherwise be one or more video camera 502. The video camera 502 may have a lens 504 that can be used for filming. The video camera 502 may be attached to the second basket 134 and may be for filming, videotaping or recording the opening to the interior 110 of the basket 108. The video camera 502 may, alternatively, be mounted to a sidewall 107 of the basket 108. The video camera 502 can be in communication with the controller 104. For example, the controller 104 may store in memory the recordings made by the video camera 502. The video camera 502 can be in communication with a computer 506, for example. The computer 506 may have a display screen on which the recorded video footage can be displayed.

The video camera 502 may be used to watch items that are placed into the basket 108 to help ensure that the item that was scanned (e.g. using a bar code reader 102) is the same item that was placed into the basket 108. The video camera 502 may always be monitoring and recording the activity in the basket 108 and may, for example, create a video feed for later viewing. For example, the video camera 502 may be in communication with the information detector (e.g. a bar code reader 102) so that when an item is read by the bar code reader 102 the video camera 502 commences recording the interior of the basket 108 for a set amount of time. Alternatively, the video camera 502 may be recording during the entire shopping trip so that all items place in or removed from the cart 100 are video recorded. The video camera 502 may transmit the recording to the control unit 104 for example. Thus, at the completion of the shopping experience, a clerk or another person can view items being placed in the cart on a video monitor (from the recording of the video camera) and check that the items being shown on the monitor match those that were scanned. Further, as shown in FIG. 8D the controller 104 may prompt a user or customer to rescan (and thus rerecord with the video camera 502) an item in the basket 108 if, for example, there is an indication of suspicious activity or as a random audit.

By way of further example, the video feed of the interior 110 of the basket 108 recorded by the video camera 502 may be fed into or read by a computer or video terminal. The video feed may be analyzed using the video terminal or computer to analyze the activity that is happening during the shopping experience (e.g. by analyzing the items placed in and removed from the basket 108 and by analyzing the corresponding bar code information). Further, this analysis may be performed in real-time while a customer is shopping using the cart 100. For example, the video feed may be communicated to the control unit 104 and may be displayed on the user interface 202 and may also be analyzed automatically by the processor of the control unit 104. The analysis may comprise a pre-programmed algorithm which tracks the item that was scanned to ensure it is the item that comes to rest in the basket and which then takes as input the weight of the items in the basket 108 (e.g. as determined by the weight detector), the bar code information and the portion of the video feed related to each item. The algorithm may output a verification that an item that was scanned was also the item that was placed in the basket 108. The algorithm can be initiated when an item is scanned by a bar code reader 102. Further, the algorithm may detect items that were placed into the basket 108 but that were not scanned by the bar code reader 102 for purchase. This can be done by detecting that there was a weight change in the basket 108 or that the video analysis 502 detected a new item passing into the basket 108. As noted, this analysis or algorithm may be performed in real time or may be performed after completion of the shopping experience. The analysis or algorithm may be performed at the control unit 104 or on a remote computer, for example.

If the analysis or algorithm operating with the video camera 502 and/or weight detector is not able to verify whether an item placed into the basket 108 of the cart 100 is the same as the item scanned by the bar code reader 104, a message may be sent to an attendant or other person (from the control unit 104 over a network, for example) indicating the inability to verify an item in the cart 100. The attendant or other person may then perform a manual check of the items in the basket 108 of the cart 100 as compared to the items scanned by the bar code reader 102. Alternatively, the control unit 104 may maintain in memory an indication that there are items in the basket 108 that cannot be verified; and, if possible, the control unit 102 may maintain in memory the identification of the items (or the time-stamp in the video feed, for example) of the items in the basket 108 that cannot be verified (e.g. as compared to the bar code information and/or the weight information as provided by the weight detector). At a later time (e.g. upon completion of shopping), an attendant or other person can manually verify the items in the basket 108. Alternatively, or additionally, the customer may be prompted by the control unit 104 to rescan items when or before returning the cart 100 (e.g. at the end of the shopping experience). The items for rescan may be randomly selected or may have been items that were not verified.

Further, there may be a verification process that selects items in the cart at random or based on the fact that they were unable to be verified by the weight detection and or video algorithms after being scanned for rescanning to confirm that those items are still within the cart and were not substituted for other items.

The verification of the items in the basket 108 may also or otherwise be performed after the consumer has completed their shopping experience. For example, the video feed and bar code information may be communicated to a computer or video terminal operated by an attendant or other person who can then perform an auditing analysis using the computer or video terminal.

Other product detectors for monitoring the products in the shopping cart 100 to verify the existence of the products may, for example, use video recognition, laser, ultrasound, white light scanner or volume calculators. Other ways of verifying the existence of products in the shopping cart 100 may be known to a person of ordinary skill in the art.

The control unit 104 may include mapping software, which indicates the location of certain products in the store. A person or consumer may enter input into the user interface 202 of the control unit 104 indicating that he or she is looking for a certain product or item. For example, the consumer may press a “locate” button 203 in FIGS. 8A-8D and in response the user interface 202 of the control unit 104 may prompt the user to enter product identification information (such as the name of a product). The control unit 104 may as shown in FIG. 8B then indicate where in the vicinity (e.g. a grocery store) that product is located. For example, the user interface 202 may indicate the location of a certain product with a map, with text, or with audio.

The “help” button 252 activates the LED light 210 so that when the help button 252 is pressed the LED light 210 is illuminated. When the “help” button 252 is pressed, the control unit 104 may send a help message through a communication network to an attendant's handheld device or to a console. The help message may, for example, indicate that a consumer or person requires assistance and may also identify the control unit 104 which is sending the message. The communication network may be a wireless network, for example. In this way a customer in a grocery store, for example, my press the “help” button 252 when that customer requires assistance regarding the control unit 104 or otherwise.

A card swipe (not shown) may also be in communication with the control unit 104. The card swipe may be for receiving payment from a payment card, such as a credit card or debit card. The point of sale device 190 may also have a transmitter (not shown) for sending payment card information to an issuing institution and a receiver for receiving confirmation of payment from the issuing institution.

In operation, when a product having a bar code is placed past the bar code reader 102 into the basket 108, the bar code reader 102 reads the bar code information (i.e. the product information) encoded on the bar code of the product, references that code with the product item details in the stores database and stores it in memory. The bar code information may include the product's identification information (e.g. the name of the product) and the price of the product. The bar code reader 102 may process the bar code information in order to parse out specific information such as the product identification and price. The bar code reader 102 then communicates this bar code information to the control unit 104. Alternatively, the bar code information may not be stored in the bar code reader 102 memory but may merely be communicated to the control unit 104.

In an embodiment, each product that is placed into the basket 108 rests or lands on the weight detection pad 120. The weight detection pad 120 measures the weight of the product (in kilograms, for example) and at least temporarily stores the weight of the product in memory. The processor in the weight detection pad 120 calculates and maintains the total weight of all products in the basket 108, for example by adding the weight of all the products in the basket 108. By way of further example, the weight of any new product may be measured by the weight detection pad 120 and the processor of the weight detection pad 120 may add the weight of the new product to the total weight of all products in the basket 108. This new total weight may then be stored in the memory of the weight detection pad 120. In this way the weight of all products is maintained in real-time in the memory of the weight detection pad 120. Alternatively, the load cells 120 may be used to measure the weight of the products placed into the basket 108. The weight detection pad 120 may be used interchangeably with the load cells 120. As noted above, when load cells 120 are used, the basket 108 rests on top of the load cells 120 so that when items are placed in or removed from the basket 108 the load cells 120 measure the corresponding change in weight in the basket 108.

The weight of all products may also (or only) be maintained in the control unit 104. The weight of each measured or monitored product in the shopping cart may be communicated by the weight detection pad 120 to the control unit 104. The weight detection pad 120 need not necessarily store in its memory or calculate (in real-time) the weight of all products in the shopping cart 100.

Further, the video camera 502 may record the items entering and/or leaving the basket 108. This recorded information may be coupled to, or associated with the information for each item as read by the bar code reader 102, for example. Thus, when a person wishes to view the recorded video footage, that person can compare the video footage to the item as read by the bar code reader 102.

After the control unit 104 receives the bar code information it cross references that information with the store's database while storing this information in its memory. The control unit 104 may also display the product identification and price on the user interface 202 so that a consumer is aware of the price of the product inserted into the shopping cart 100.

Any tags on products being purchased may be removed using the tag remover 238, preferably after the products are purchased, as described below. For example, plastic security tags may be removed from products using the tag remover 238.

A similar process may be undertaken each time an additional product with a bar code is inserted into the shopping cart 100 basket 108. The control unit 104 may display all product identification information and price in columns on the user interface 202. The control unit 104 may also calculate a total cost of the products in the shopping cart 100. For example, as shown in FIG. 8C, the processor of the control unit 104 may add together the prices of all the products in the shopping cart 100 basket 108, as stored in memory, and may display the resulting cost on the user interface 202.

If the shopping cart 100 basket 108 contains products and a product is removed from the basket 108, the weight detection pad 120 will detect a corresponding weight differential. For example, the total weight of products in the basket 108, as maintained in the memory of the weight detection pad 120, is 10 kg and a product weighing 1 kg is removed from the basket 108, the processor in the weight detection pad 120 will calculate that the total weight of products in the basket is 9 kg. In this way the weight detection pad 120 determines that a product has been removed from the basket 108. When the removed object passes the bar code reader 102 then the bar code reader 102 will read the bar code information and communicate that information to the control unit 104, as described above. An indication that the product is being removed from the basket 108 is included in the bar code information. When the control unit 104 receives the bar code information from the bar code reader 102, the control unit 104 may store the bar code information in its memory. The price of the removed product, as received in the bar code information, the removed product's identification and an indication that the product is removed from the shopping cart 100 may be displayed on the user interface 202 of the control unit 104. The price may be subtracted from the cost of all products in the shopping cart 100. The resulting cost may be stored in the control unit's 104 memory and/or displayed on the user interface 202. The calculation of the price of the items or products may be performed in real-time by the control unit's 104 processor in response to receiving bar code information.

Certain products that consumer's may wish to purchase may not have a bar code. Such products may include bulk foods or produce, for example. These products may be priced based on the weight of the product and a specific price per weight value. A scale (not shown) may be provided in the store where the consumer is gathering products for purchase. The scale may have a user interface for inputting information, a processor and memory, which may be firmware for example. A product may be placed on the scale and the product information, such as the product identification and/or the product's price per weight information may be entered into the user interface of the scale by the consumer or an attendant. This information may then be stored in the memory of the scale. When the product is weighed on the scale the processor calculates the price for the weighed product based on the price per weight value stored in memory and the product identification information stored in memory.

If a consumer places a product that does not have a bar code into the shopping cart 100, the weight detection pad 120 will detect the weight of the product and may communicate the new weight to the control unit 104. The control unit 104 may display a message on the user interface 202 that there is an additional product in the shopping cart 100 for which the control unit 104 did not receive any bar code information. If the consumer or attendant has determined the price of the product using the scale, as described above, the consumer or attendant may enter the price and/or identification information of the product into the memory of the control unit 104 by typing the product information and price into the keypad 222. For example, the control unit 104 may prompt the consumer to enter the product name (e.g. by a message on the user interface 202), which the consumer can then type into the keypad 222. After the consumer presses the “enter” button 244, the control unit 104 may prompt the consumer to enter the price of the product (e.g. by a message on the user interface 202). The consumer can then enter the price of the product into the keypad 222. Alternatively, the price may be entered before the product name (or identification information). The product name and price may then be displayed on the user interface 202 of the control unit 104.

If the consumer or attendant incorrectly enters product name or price, that consumer or attendant can press the “clear” button 240 which clears the information from the user interface 202 and/or memory that was input. This allows the consumer or attendant to re-enter the product name or price, for example.

The prices and names of all of the products in the shopping cart 100 may be displayed on the user interface 202. If the number of products is more than can be displayed on the user interface 202, the consumer may be able to scroll up and down on the user interface 202 using, for example, arrow keys (not shown).

Alternatively, the scale may print out a bar code for the product being weighed. For example, if a consumer is purchasing produce fresh meat or poultry (or other products that do not have a bar code) from a grocery store, an attendant may weigh the produce, fresh meat or poultry on a scale, as described above, and the scale may print out a bar code. The fresh meat or poultry may be wrapped in paper (e.g. wax paper) or placed in a plastic bag and the bar code may be stuck on the paper with adhesive. Thus, when the packaged produce, meat or poultry is placed into the shopping cart 100 the bar code reader 102 will read the bar code information from the bar code printout. The bar code reader 102 may then communicate this bar code information to the control unit 104, as described above.

In an alternative embodiment, the bar code reader 102 may be a handheld device whereby the consumer or attendant scans the bar codes of each product before or after inserting them into the shopping cart 100. This handheld device may be in communication with the video camera 502. For example, each time the handheld bar code reader 102 reads the bar code from an item, the video camera 502 may record the interior 110 of the basket 108 for a set period of time so that the item is recorded. The recorded video and the bar code information may be coupled together in memory so that they can later be retrieved and analyzed.

It is understood that the point of sale device 190 may be retrofitted to various sizes of shopping carts 100.

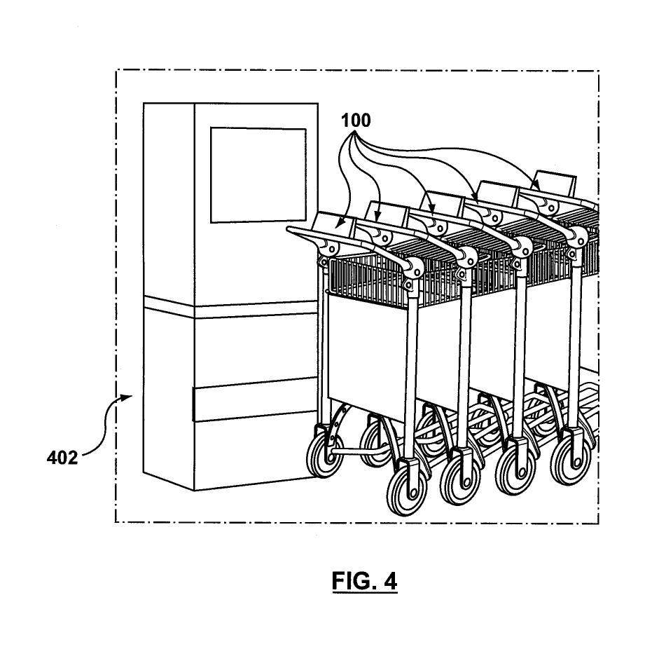

Referring to FIG. 4, a docking station 402 similar to those used at airports for baggage carts may be used to dock the shopping cart 100. In this embodiment, the shopping carts 100 are locked together in the docking station. A consumer enters the stores, approaches the shopping cart 100 area and swipes his or her credit card or debit card in the docking station control panel to release a shopping cart 100. The control panel places a pre-authorized charge on the shopping cart 100 to be released or cancelled once the shopping cart 100 is put back into the docking station either in the store or in the parking lot as an incentive to return the cart to the docking station.

The docking station 402 may be connected to a computer with memory and a processor. The data (e.g. video recordings, bar code readings, etc.) on the control unit 104 may be downloaded to the computer connected to the docking station.

Alternatively, the control unit 104 may be a portable or mobile device. The mobile control unit 104 may be recharged at a docking station (not shown). For example, there may be a docking station at a terminal inside of a grocery store.

Further, customers may have to log on to the control unit 104 by providing a user identification word or number and/or a password and/or other personal information. This login information may be stored in the control unit 104 or in the computer connected to the docking station. Additionally, the control unit 104 may prompt the user to present an identification card, or credit card or other information card to the control unit 104 to be read by the bar code reader 102.

Further, the control unit 104 may prompt the user to present a loyalty card, if available, to the control unit 104 to be read by the bar code reader 102. For example, users or customers may sign up with a service at a store (e.g. a grocery store) whereby they receive a loyalty card that can be used to access a control unit 104. Further, the loyalty card may be used to access a user's account at the store and may be a rectangular plastic card with account number information and a bar code representing their account or it may be used to provide promotions to the user (such as reward points or coupons). The loyalty card may be a rectangular plastic card with account number information and a bar code representing their account or it may be a USB key that may connect to a laptop or other computer 506 attached to or associated with the cart 100.

Further the control unit 104 may automatically recognize and authenticate the presence of a specific customer and log them in automatically by detecting and recognizing the unique Bluetooth code associated with a hand held device such as a cell phone.

Users or customers may be able to access their store account through the Internet, or another network. For example, a customer at a grocery store may be able to create a shopping list and communicate that shopping list through the internet to their account at the store. While shopping at the store the user or customer can then access that shopping list by logging into their account or using a loyalty card. The shopping list may then be displayed, for example, on a display screen of the computer 506 or, as shown in FIG. 8A, on the user interface 202.

Opposing security posts (not shown) may be located in the entrance or exit to a store in which the point of sale device 190 is used. The security posts may, for example, comprise an alarm. The alarm may be activated when a control unit 104 passes between the two security posts. The control unit 104 can communicate with the security posts through a wireless network (e.g. a local area network). Thus, when there are no outstanding items to be paid for as indicated on the control unit 104, the control unit 104 may temporarily deactivate the security posts so that that particular control unit 104 can pass through the security posts without activating the alarm.

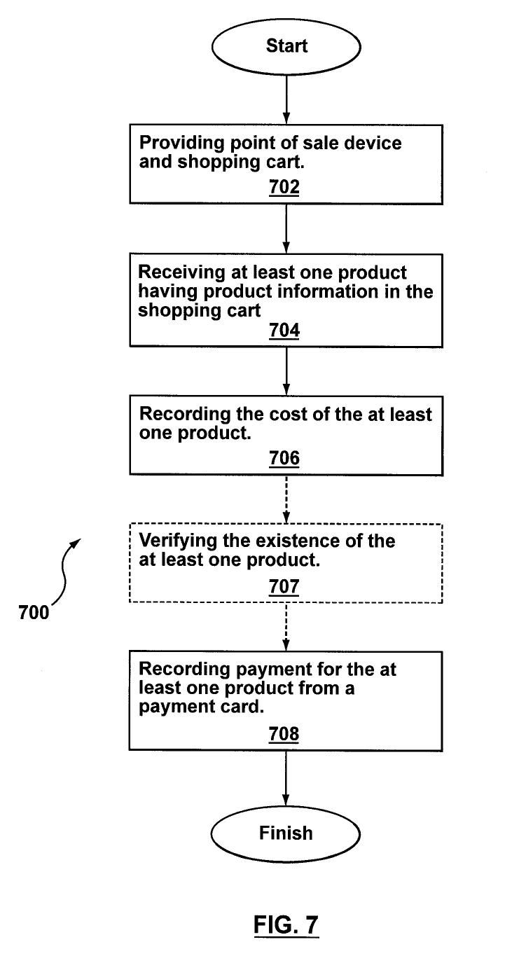

A method of operating the shopping cart 100 and point of sale device 190 is depicted at 700 in the flow chart of FIG. 7. At step 702, the shopping cart 100 with a point of sale device 190 mounted thereto, as described herein, is provided. At step 704, at least one product or item having product information (e.g. a grocery item) is received into the shopping cart 100 (e.g. by a consumer placing the product into the shopping cart 100). The product information may be, for example, a bar code or an RFID tag. As noted above, the bar code reader 102 can read the bar code from the item and communicates the resulting bar code information to the control unit 104. Similarly, the RFID tag can be read by an RFID tag reader and the RFID tag reader can communicate the resulting bar code information to the control unit 104. The total cost of the products held in the shopping cart 100 may be displayed on the display screen 202.

At step 706, the cost of the at least one product is recorded. For example, the cost may be recorded on the control unit 104, as described above. When the consumer wishes to pay for the products contained in the shopping cart 100, the consumer selects the “pay now” button 254. At this point a message may be displayed on the display screen 202 indicating the payment amount required (i.e. the cost, plus applicable taxes) such as shown in FIG. 8C. When the “pay now” button 254 is selected, one of the LED lights 208 may be illuminated to indicate to the consumer or an attendant that a transaction is complete.

At step 707, the existence of the at least one product in the shopping cart 100 is verified. This may be done using a product detector, such as a weight detection pad 120, described above. For example, if the weight detection pad communicated either a change in the total weight of the products in the shopping cart 100 or an additional new weight in the shopping cart 100 to the control unit 104, the existence of the at least one product in the shopping cart 100 will be verified. Otherwise, the existence of the at least one product in the shopping cart 100 will not be verified. In the latter case, the control unit 104 may subtract the price of the at least one product from the running total cost.

Any product identification detected by the information detector (e.g. from information scanned from RFID tags or from bar codes) may be accompanied by a product verification verified by the product detector (e.g. using a weight detection pad 120). Therefore, when the prices of the products in the shopping cart are used to calculate to total cost of the products in the shopping cart 100, the existence of the products corresponding to each price are verified. As a result, the total cost calculated by the control unit 104 accurately reflects the total cost of the products in the shopping cart 100.

At step 708, payment from a payment card for at least one item is received. Payment cards may include debit or credit cards, for example. To pay for the item, the consumer may swipe at least one of a credit card or debit card in the card swipe. The control unit 104 will deduct or debit from the credit card or debit card the amount of money or cost of the items as calculated by the control unit 104 (i.e. the total cost obtained from the data extracted from the bar codes of each item in the shopping cart 100, plus any applicable taxes). The total cost of the products may be displayed on the user interface 202. If required, the consumer can enter a PIN number for the debit card or credit card using the numerical keypad 222. For example, if a debit card is swiped in the card swipe, the control unit 104 may prompt the consumer to enter a PIN number by displaying a message on the user interface 202. Once the payment is authorized (e.g. by an issuing institution over a communication network), the items in the shopping cart 100 have been purchased. At this point the receipt dispenser 236 may print the receipt for the purchased items. Payment may also happen without swiping a card. Upon hitting the pay now button the control unit 104 may communicate wirelessly with a server in the store or via the internet to a central location where payment details reside. The transaction would then be executed at that location and a message sent back to the control unit authorizing the transaction.

The information detector may be an RFID tag reader. Product information for a product may be encoded on an RFID tag attached to that product. The RFID tag reader may read the product information encoded on the RFID tags, which are attached to products. Alternatively, the RFID tag reader may be integrated with a handheld device. In the latter case, a consumer or attendant would be required to scan the RFID tags for each product in the shopping cart 100 using the handheld RFID tag reader. For example, the RFID tag reader could scan and/or read the product information encoded on the RFID tags attached to the products that are placed in or are resting in the interior 110 of the shopping cart 100. The RFID tag reader may be attached to the shopping cart 100. Alternatively, the RFID tag reader may be part of the control unit 104.

Similarly, the product detector may be the RFID tag reader. For example, when the RFID tag reader scans (or reads or detects) the RFID tags from the products being placed in or removed from the shopping cart 100, the RFID tag reader may keep track of (e.g. by detecting) the number of products in the shopping cart 100. Alternatively, or in addition, the RFID tag reader may monitor the products as they are placed in or removed from the shopping cart 100 and communicate this information to the control unit 104. For example, each time a product is placed into the shopping cart 100, the RFID tag for that product may be scanned and a message may be communicated to the control unit 104 that a product is being placed into the shopping cart 100. Similarly, the RFID tag reader can communicate a message to the control unit 104 indicating that a product is removed from shopping cart 100 (i.e. when a product is removed). The control unit 104 may keep a running total of the number of products in the shopping cart 100.

The product information encoded on the RFID tags may include some or all of the following information: product price; product identification; product expiry date; product weight; and/or product manufacture date.

The RFID tag reader may have memory for storing data or information (such as RFID tag information) and a processor for executing instructions. When the RFID tag reader has read at least some of the information from an RFID tag of a product, that information may then be communicated to the control unit 104. The RFID tag reader may be connected to a wireless network, such as the Internet or a local area network, in order to communicate with the control unit 104. The information communicated from the RFID tag reader to the control unit 104 may be displayed on the user interface 202, for example.

The RFID tag reader may perform similar operations in relation to the RFID tags as those performed by the bar code reader 102 in relation to the bar codes described above.

One or more currently preferred embodiments have been described by way of example. It will be apparent to persons skilled in the art that a number of variations and modifications can be made without departing from the scope of the invention as defined in the claims.

What is claimed is:

1. A point of sale device for use with a shopping cart, the shopping cart having a basket for holding products, the basket having a bottom and an upstanding sidewall extending from the bottom and defining an open top, comprising:
a product detector for detecting at least the presence of products in the basket;
a control unit communicating with the product detector, the control unit having a user interface with a display screen; and,
an information detector communicating with the control unit for detecting product information and sending the product information to the control unit,
wherein the control unit communicates with a calculator which calculates the cost of the products in the basket of the shopping cart using the product information and displays at least the cost of the products on the display screen.

2. The point of sale device of claim 1, wherein the detector verifies the nature of the products in the basket.

3. The point of sale device of claim 1, wherein the product detector is a weight detector connected to the basket for weighing products in the basket.

4. The point of sale device of claim 1 wherein the product detector is at least one of a weight detection pad and load cells.

5. The point of sale device of claim 1, wherein the product detector is a video analytic tool associated with a video camera mounted on the shopping cart.

6. The point of sale device of claim 1, wherein the information detector is a bar code reader for reading a bar code on the product.

7. The point of sale device of claim 1, wherein the information detector is a radio-frequency identification (“RFID”) tag reader and the product information is encoded on an RFID tag.

8. The point of sale device of claim 7, wherein the product detector is the RFID tag reader.

9. The point of sale device of claim 1, wherein the open top of the shopping cart has an edge extending thereabout and, the information detector is attached to the edge for reading bar code information from products as the products pass past the bar code reader through the open top and into the interior of the shopping cart.

10. The point of sale device of claim 1, wherein the control unit is attached to the shopping cart with the user interface facing the user.

11. The point of sale device of claim 1 wherein the control unit communicates with a database for obtaining product information.

12. The point of sale device of claim 1, wherein the calculation of the cost of the products is performed in real-time in response to receiving product information.

13. The point of sale device of claim 1 further comprising a card swipe communicating with the control unit for reading a payment card.

14. The point of sale device of claim 1 further comprising a receipt dispenser communicating with the control unit for dispensing receipts.

15. The point of sale device of claim 1 further comprising a transmitter associated with the control unit for transmitting via wifi to a server or via the internet to a site on which customer's account is stored for execution of the transaction.

16. The point of sale device of claim 1 wherein the control unit communicates with a central kiosk or self serve checkout terminal having receipt printing capabilities.

17. The point of sale device of claim 1 wherein the control unit communicates with an accounting/inventory system of a business utilizing the point of sale device.

18. The point of sale device of claim 14, wherein at least one of the control unit and the card swipe has a numerical keypad for receiving a pin number.

19. The point of sale device of claim 1, wherein the user interface is a touch screen interface.

20. The point of sale device of claim 1, wherein the control unit is powered by a lithium battery.

21. The point of sale device of claim 3 further comprising a scale for weighing selected of the products, the scale having an output for outputting product information.

22. A method of selling items, comprising the steps of:
(i) providing the point of sale device and a shopping cart as defined in claim 4;
(ii) receiving at least one product having product information in the shopping cart;
(iii) recording the cost of the at least one product; and
(iv) receiving payment for the at least one product from a payment card.

23. The method of claim 22 further comprising the step of: verifying the at least one product's existence.

24. The method of claim 23, wherein the step of verifying the at least one product's existence occurs before the step of receiving payment for the at least one product from a payment card.

25. The method of claim 23, wherein the step of verifying the at least one product's existence comprises at least one of monitoring the weight of the products in the shopping cart and using video algorithms for analyzing video information.

26. The method of claim 22 wherein the product information is at least one of an RFID tag and a bar code.
